(19) United States
(12) Patent Application Publication
(10) Pub. No.: US 2005/0211901 A1
(43) Pub. Date: Sep. 29, 2005

(54) Method for determining the substitutional carbon content in monocrystalline or polycrystalline silicon

(75) Inventors: Ivo Crossmann, Burghausen (DE); Hans Christian Alt, Oberhaching (DE)

Correspondence Address: WILLIAM COLLARD;COLLARD & ROE, P.C., 1077 NORTHERN BOULEVARD, ROSLYN, NY, 11576, US

(73) Assignee: WACKER-CHEMIE GmbH

(21) Appl. No.: 11/079,626

(22) Filed: Mar. 14, 2005

(30) Foreign Application Priority Data
Mar. 26, 2004 (DE) 10 2004 014 984.4

(51) Int. Cl. G01N 21/35

(52) U.S. Cl. 250/339.12

(57) ABSTRACT

A method for determining the substitutional carbon content (Cₛ) of a monocrystalline or polycrystalline silicon sample comprises measuring an absorption spectrum of the silicon sample to be studied and of a reference sample and calculatng a differential spectrum from them, wherein the calculated differential spectrum provides a detection threshold of <5 ppba Cₛ.

### BACKGROUND OF THE INVENTION

1. Field of the Invention

The invention relates to a method for determining the substitutional carbon content in monocrystalline or polycrystalline silicon by means of infrared spectroscopy and the formation of normalized differential spectra.

2. The Prior Art

Substitutional carbon (Cₛ) in crystalline silicon, i.e., carbon which is located at lattice sites, is determined with the aid of Fourier transform infrared (FT-IR) spectroscopy. The intensity of the absorption by the vibrational mode of the carbon isotope ¹²C at 605 cm⁻¹ is in this case proportional to the carbon content. The position of this mode is temperature-dependent and shifts toward higher wavenumbers at lower temperatures (77 K: 607.5 cm⁻¹). The low-temperature FT-IR method (measurement at 77 K) is used in order to achieve low detection thresholds. The thermally excited lattice modes of the silicon crystal then are “frozen in”. The lattice modes (phonons) greatly affect the measurement of carbon, since the C mode used to determine the carbon lies on the edge of the two phonon absorption [TO(C)+TA(X)]³ of the silicon crystal. A differential spectrum is created in order to eliminate the effect of this Si sublattice absorption on the evaluability of the infrared spectrum: A carbon-free silicon sample (reference sample) which may be produced by repeated float zone pulling of the same silicon crystal in a vacuum, for example, is measured using the same method as a silicon sample to be studied. By subtracting the spectra of the two samples, identical absorption bands (Si sublattice absorptions) are eliminated while spectral differences (for example due to a different Cₛ content) are significantly emphasized. The combination of low-temperature measurement and formation of differential spectra allows detection thresholds of about 20 ppba.

This procedure (measurement setup, sample preparation) is described at length in ASTM F1391-93 (2000) (Annual Book of ASTM Standards, Vol. 10.05., April 2003, hereby incorporated by reference) and is used as a standard measurement method in the semiconductor industry for determining the carbon content in silicon. Further description of an apparatus suitable for this measurement, and of another differential spectrum method can be found in European Patent 0590962 B1 (Shin-Etsu Handotai 1992), also incorporated by reference. As an alternative to measurement on monocrystalline silicon, it is also possible to use annealed polycrystalline silicon. This is described, for example, in L. Hwang, J. V. Bucci, J. R. McCormick: “Measurement of Carbon Concentration in Polycrystalline Silicon Using FTIR”, J. Electrochem. Soc., 1991, 138, 576.

Only limited opportunities are available for lowering the detection threshold for the FT-IR method further. Further reducing the temperature from 77 K (liquid nitrogen for detector and sample cooling) to 4 K (liquid helium), in order to lessen the thermal lattice modes of the silicon crystal even more, does not offer a significant improvement. Even minor differences in the absorption spectra of the reference and sample materials (=absolute absorption values at determined wavenumbers) lead to deviations such as slight signal shifts in the differential spectrum, and can cause relatively great perturbations and limited reproducibility for the spectral evaluation. Moreover, evaluation of the differential spectrum is hindered by the poorly definable position of the baseline which is used for determining the peak height (=absorption of the peak maximum minus absorption of the baseline at the same wavenumbers) and the reproducibility of the evaluation is also restricted by this.

The strive for higher and higher purities of monocrystalline or polycrystalline silicon necessitates ever more sensitive detection methods for determining the substitutional carbon content. A lower detection threshold allows highly pure polycrystalline silicon to be characterized better according to the requirements of the semiconductor and photovoltaic industries.

### SUMMARY OF THE INVENTION

The invention relates to a method for determining the substitutional carbon content (Cₛ) of a monocrystalline or polycrystalline silicon sample in which an absorption spectrum of the silicon sample to be studied and of a reference sample are measured and a differential spectrum is calculated from them, wherein the calculated differential spectrum provides a detection threshold of <5 ppba Cₛ.

The detection threshold may, for example, be calculated from the differential spectra obtained according to the invention in analogy with the blank value method described in the DIN standard DIN 32645.

The reference sample is silicon, which has a higher substitutional carbon purity than the silicon sample. The reference sample is preferably carbon-free.

The method according to the invention uses a combination of simple mathematical operations for calculating the differential spectrum, which modify the absolute spectral data but not the relative ratios of the two absorption spectra which are crucial for correct evaluation (for example determining the substitutional bound carbon Cₛ).

It has been found that these mathematical operations make it possible to exactly establish the baseline in the differential spectrum with respect to variation and absolute absorption, on the one hand, and on the other hand to minimize perturbations in the differential spectrum over the relevant measurement range. This permits reproducible error-free determination of the peak height as the difference between the absorption on the peak maximum at 607.5 cm⁻¹ and the absorption of the baseline at 607.5 cm⁻¹ (defined as being zero according to the invention).

The mathematical matching and subtraction procedure used for the spectra in the method according to the invention can avoid the deficiencies of the spectral evaluation known from the prior art. After adjusting substance-specific parameters, for example the wavenumber ranges, the method according to the invention can in principle also be applied to the determination of infrared-active impurities other than C₅, for example oxygen, nitrogen, boron, phosphorus, arsenic, aluminum or antimony, in infrared-transparent matrices, for example silicon, germanium or III-V semiconductor materials such as gallium arsenide (GaAs) or cadmium telluride (CdTe) or other compound semiconductors which can be employed in solar cell technology and the electronics industry.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows the basic structure of an FT-IR spectrometer for producing the absorption spectra of a silicon sample and a reference sample;

FIG. 2 shows the absorption spectra of the silicon sample and the reference sample as produced using an FT-IR measurement apparatus according to FIG. 1;

FIG. 3 represents the first step of the processing with reference to the example of the absorption spectrum of the sample material;

FIG. 4 represents the second and third steps of the processing of the sample material;

FIG. 5 represents the fourth step of the processing of the sample material;

FIG. 6 represents the fifth step of the processing of the sample material; and

FIG. 7 represents the fifth step of the processing of the sample material, and also shows a differential spectrum according to the ASTM method (prior art) for comparison. The differential spectrum according to ASTM 1391-93 (2000) is shifted by −0.32 absorption units for the sake of clarity.

### DETAILED DESCRIPTION OF THE PREFERRED EMBODIMENT

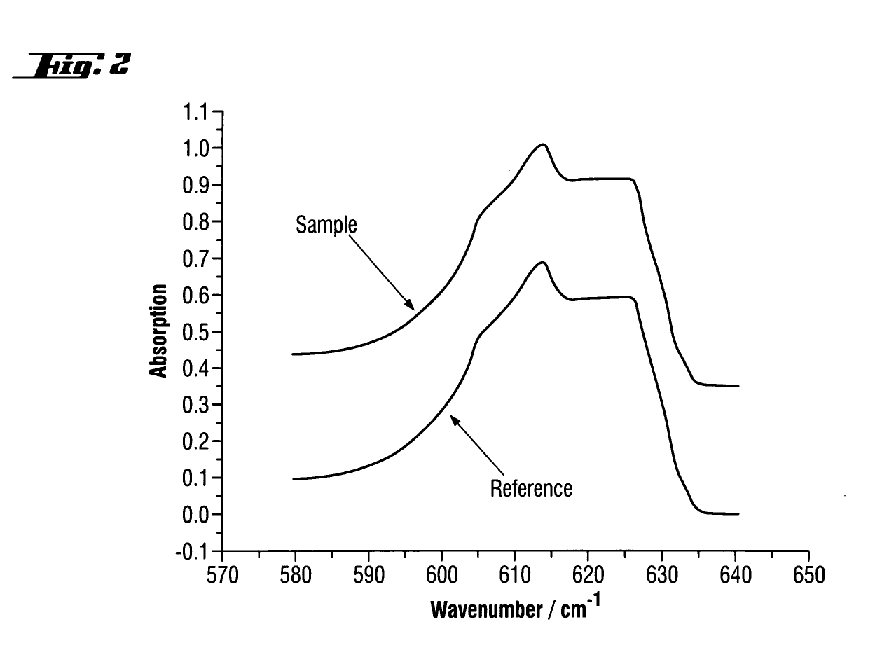

The method according to the invention will be described by way of example below, the individual steps according to the invention being illustrated with the aid of spectral representations in FIG. 2 to FIG. 7. Here, the spectral range between 580 cm⁻¹ and 640 cm⁻¹ is used as the relevant measurement range. The following values are assumed for the other wavenumbers a, b and x: x=640 cm⁻¹, a=620 cm⁻¹ and b=595 cm^{-1.}

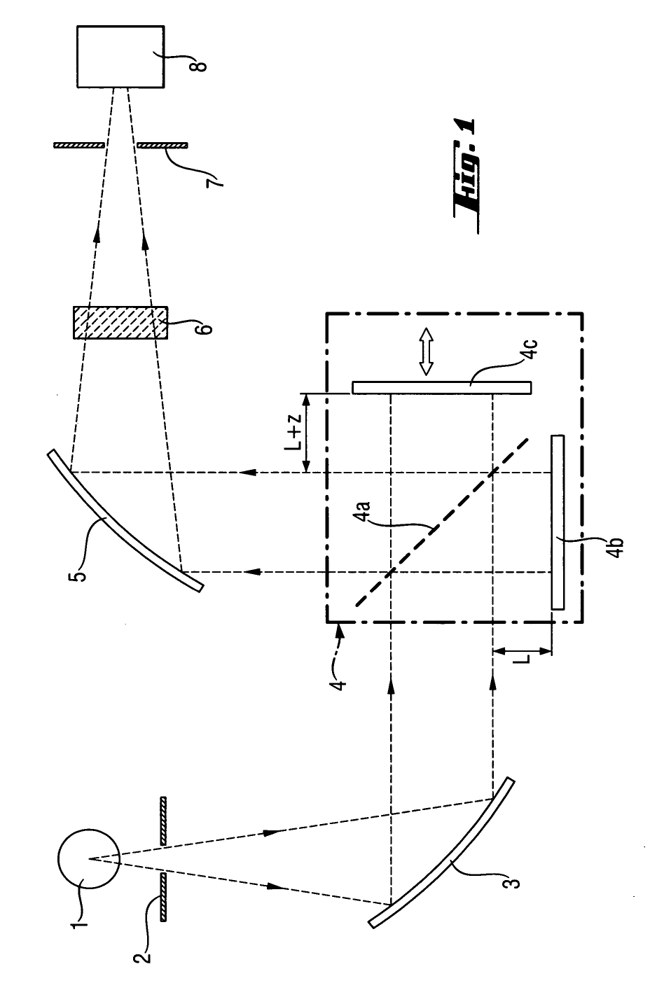

Absorption spectra (FIG. 2) of a silicon sample and a silicon reference sample (referred to below as the sample and reference materials) are recorded using infrared spectroscopic measurement apparatus as shown in FIG. 1. Fourier transform infrared spectrometers (FT-IR spectrometers) are preferably used for producing these absorption spectra. Such an infrared optical system consists of an infrared light source (1), for example a globar, an aperture (2) and a collimator system (3) to make the emerging infrared radiation parallel when it enters a subsequent Michelsen interferometer (4). The Michelsen interferometer consists essentially of a beam splitter (4a), a stationary mirror (4b) and a moving mirror (4c). The beam splitter reflects 50% of the incident light intensity to the stationary mirror (path length traveled by the infrared light: 2·L) and transmits 50% of the incident radiation to the moving mirror. The variable distance between the mirror and the beam splitter (path length traveled by the infrared light: 2·(L+z)) can be used in this second optical path to create a phase shift due to the different path length traveled by the infrared light (path length difference: 2·z) which, owing to the spatial coherence, leads to interfering waves at the beam splitter when they are combined after the reflection. Upon leaving the Michelsen interferometer, and after concentration by a convergent mirror (5), the infrared radiation passes through the infrared-transparent sample (6) and is focused by another aperture system (7) onto the detector (8). The signal produced in the detector is digitized by an analog-digital converter and subsequently Fourier-transformed electronically. An absorption spectrum produced using this measurement setup is represented in FIG. 2.

A spectral range which is as narrow as possible, but which contains all the necessary information about the infrared spectrum and is not affected by other infrared impurities in the silicon lattice, is selected for the measurement value processing essential to the invention. It is preferably selected so that its limit on the low-energy side is not affected by the infrared-active defects in the crystal lattice at 570 cm⁻¹, while its limit on the high-energy side is as close as possible, preferably nearer than 10 cm⁻¹, to the two phonon absorption of the silicon lattice. The information required is, for example, the two phonon absorption of silicon and the Cₛ mode at 607.5 cm^{-1.}

In what follows: S(w) and R(w) denote the respective absorption in the sample or reference spectrum as a function of the wavenumber w (unit: cm⁻¹). Other letters in brackets, for example S(x), refer to the relevant absorption at a particular wavenumber, here x.

The first step of the procedure is to establish the zero point of the absorption spectra of the sample and reference materials at a wavenumber x, i.e. the absorption at x is subtracted from the absorption at each wavenumber:

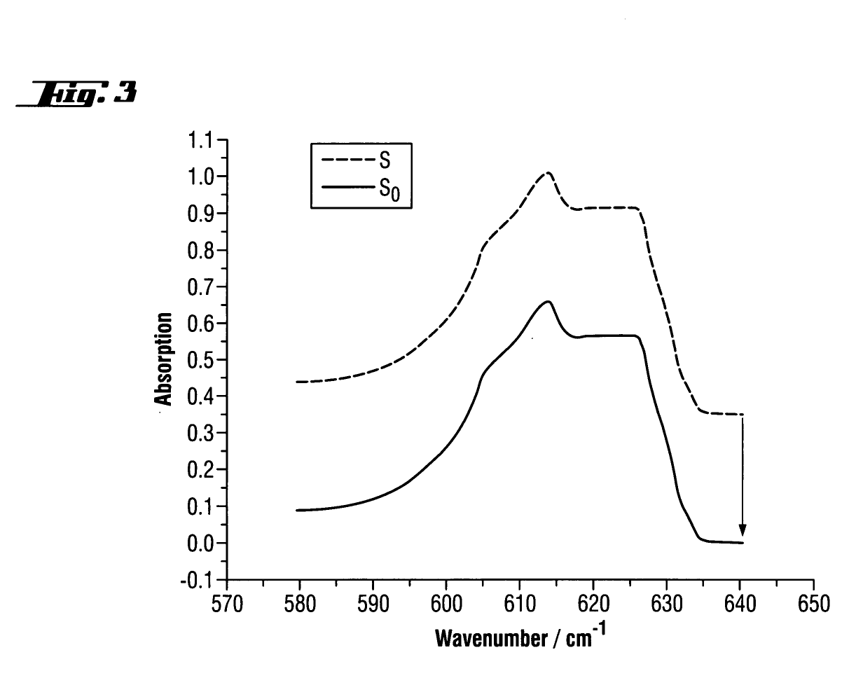

S₀(w)=S(w)−S(x) (FIG. 3) and R₀(w)=R(w)−R(x)

The wavenumber x is selected so that it lies in the region free from spectral perturbations on the high-energy side of the two phonon absorption, and the distance from this signal should be as small as possible, preferably less than 10 cm^{-1.}

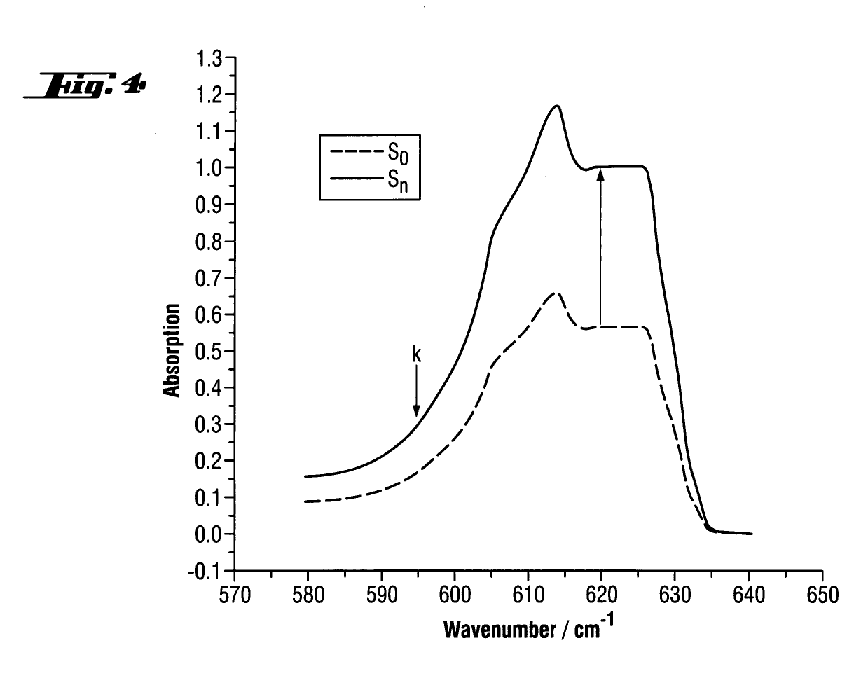

The second step is to define a further fixed point in the sample spectrum S₀(w) obtained according to Step 1. To this end, a wavenumber a is selected in the plateau region of the two phonon absorption between 618 cm⁻¹ and 626 cm⁻¹, where the absorption of the sample spectrum S₀(w) is set equal to one, i.e. the absorption at each frequency of the spectrum is divided by the absorption at a (FIG. 4):

$${S}_{n} ( w ) = \frac{{S}_{0} ( w )}{{S}_{0} ( a )} .$$

The normalized absorption k at a wavenumber b is determined in a third step from the absorption spectrum Sₙ(w) of the sample as normalized according to Steps 1 and 2, b being defined with the position symmetrical to a around the measurement wavenumber z (at 77K: 607.5 cm⁻¹) (FIG. 4):

$${S}_{n} ( b ) = k with z = \frac{a + b}{2} .$$

The fourth step is used to match the absorption spectrum of the reference material to the absorption spectrum of the sample material, but without changing the relative ratios within the spectra. The correction value Y(w) needed for this is calculated according to

$$Y ( w ) = m \cdot p ( w ) with$$

$$m = \frac{( \frac{x - b}{x - a} ) \cdot [ ( k \cdot {R}_{0} ( a ) ) - {R}_{0} ( b ) ]}{( \frac{x - b}{x - a} ) - k} and$$

$$p ( w ) = \frac{. x - w}{x - b} .$$

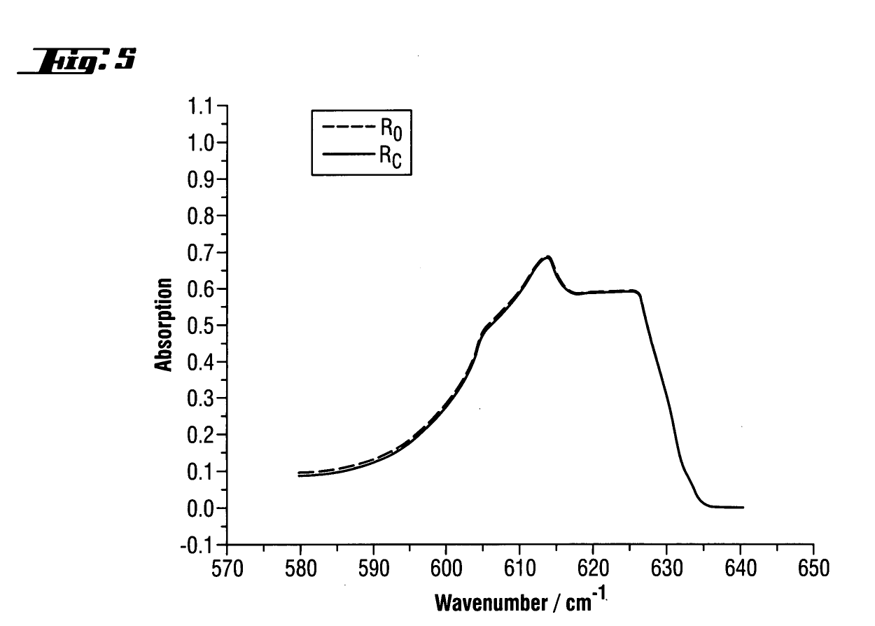

The corrected reference spectrum R_{c}(w) is calculated from this according to (FIG. 5): R_{c}(w)=R₀(w)+Y(w).

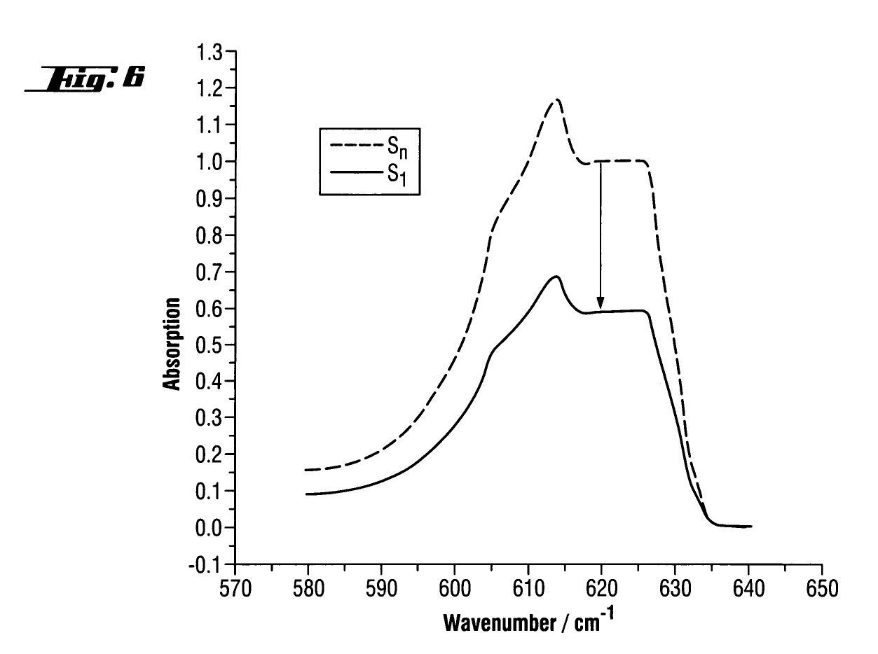

In order to match the absolute levels of the absorption spectra of the reference and sample materials, the absorption spectrum of the sample material Sₙ(w) as normalized according to Steps 1 and 2 is multiplied by the absorption of the corrected absorption spectrum R_{c}(w) at the wavenumber a in a fifth step (FIG. 6): S₁(w)=Sₙ(w)·R_{c}(a).

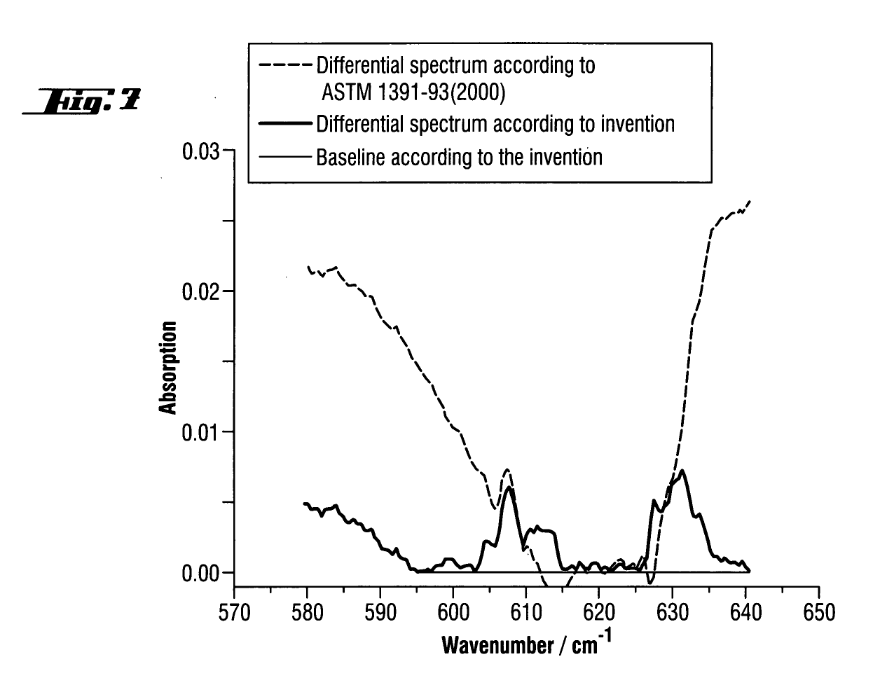

For the final calculation of the differential spectrum D(w), the difference between the absorption spectrum of the sample material S₁(w) according to Step 5 and the corrected absorption spectrum R_{c}(w) is taken in a sixth step, and multiplied by the ratio of the absorption of the spectrum of the sample material S₀ from Step 1 and the absorption of the corrected spectrum of the reference material R_{c}, in each case at the wavenumber a (FIG. 7):

$$D ( w ) = ( {S}_{1} ( w ) - {R}_{c} ( w ) ) \cdot \frac{{S}_{o} ( a )}{{R}_{c} ( a )}$$

The multiplication of the spectral difference by this ratio makes it possible to obtain the level changes in the original absorption spectrum of the sample by manipulating the signal amplitude of the spectrum of the sample in Steps 2 and 5. This ensures that the amplitude of the absorption of the original spectrum, which is crucial for evaluating the spectrum, remains unchanged.

A baseline passing through zero is established for the two spectra by Steps 4, 5 and 6 at the wavenumbers a, b and x.

The carbon content [Cₛ] of the sample is then in turn determined according to the method described in ASTM standard F1391-93 (2000) by evaluating the peak height as the difference between the absorption on the peak maximum A_{P} at 607.5 cm⁻¹ and the absorption of the baseline A_{B} at this same wavenumber, and multiplication by a calibration factor:

$$[ {C}_{s} ] = \frac{0.74 \cdot {10}^{- 3} \cdot 23.03}{X} ( {A}_{p} - {A}_{B} )$$

(concentration indicated in ppba) taking into account the sample thickness X.

Preferably by repeated measurement of the absorption spectrum of a carbon-free sample and formation of the differential spectrum, the detection threshold [Cₛ]_{DTH} of 2.9 ppba can be calculated from the resulting mean signal intensity at 607.5 cm⁻¹ and its standard deviation c by the blank value method as described in DIN standard DIN 32645, according to

[Cₛ]_{DTH}=3σ.

Accordingly, while only a few embodiments of the present invention have been shown and described, it is obvious that many changes and modifications may be made thereunto without departing from the spirit and scope of the invention.

1. A method for determining the substitutional carbon content (Cₛ) of a monocrystalline or polycrystalline silicon sample, comprising:
measuring an absorption spectrum of the silicon sample to be studied and of a reference sample; and
calculating a differential spectrum from said absorption spectra, wherein the calculated differential spectrum provides a detection threshold of <5 ppba Cₛ.

2. The method as claimed in claim 1, wherein the calculation of the differential spectrum from the absorption spectra comprises a mathematical transformation, which establishes a baseline with respect to variation and absolute absorption, and minimizes perturbations of differential spectrum over a relevant measurement range.

3. The method as claimed in claim 1, wherein:
(1) a zero point of the absorption spectrum of the sample and of the reference sample at a wavenumber x is established in a first step by subtracting absorption at the wavenumber x from absorption at each other wavenumber
S₀(w)=S(w)−S(x) and R₀(w)=R(w)−R(x)
(2) a further fixed point in the sample spectrum obtained according to Step 1 is defined in a second step by selecting a wavenumber a in a plateau region of two phonon absorption between 618 cm⁻¹ and 626 cm⁻¹, where absorption of the sample spectrum S₀(w) is set equal to one
$${S}_{n} ( w ) = \frac{{S}_{0} ( w )}{{S}_{0} ( 620 )} ;$$
(3) a normalized absorption k at a wavenumber b is determined in a third step from the absorption spectrum Sₙ(w) of the sample as normalized according to Steps 1 and 2, b being defined with a symmetrical position to a around measurement wavenumber z (at 77K: 607.5 cm⁻¹)
$${S}_{n} ( b ) = k with z = \frac{a + b}{2} ;$$
(4) the absorption spectrum of the reference sample is matched to the absorption spectrum of the sample in a fourth step using a correction value Y(w), without changing relative ratios within the spectra, so as to obtain a corrected reference spectrum R_{c}(w);
(5) absolute levels of the absorption spectra of the reference sample and of the sample are matched in a fifth step through multiplication of the absorption spectrum of the sample material Sₙ(w) as normalized according to Steps 1 and 2 by the absorption of the corrected absorption spectrum R_{c}(w) at the wavenumber a S₁(w)=Sₙ(w)·R_{c}(a),
(6) the differential spectrum D(w) is finally calculated in a sixth step by taking a difference between the absorption spectrum of the sample material S₁(w) according to Step 5 and the corrected absorption spectrum R_{c}(w), and multiplying said difference by the ratio of the absorption of the spectrum of the sample material S₀ from Step 1 and the absorption of the corrected spectrum of the reference material R_{c}, in each case at the wavenumber a,
$$D ( w ) = ( {S}_{1} ( w ) - {R}_{c} ( w ) ) \cdot \frac{{S}_{o} ( a )}{{R}_{c} ( a )} ;$$
(7) a baseline passing through zero at the wavenumbers a, b and x is established by Steps 4, 5 and 6 for the absorption spectra of the sample and the reference sample; and
(8) carbon content of the sample is then determined according to a method described in ASTM standard F1391-93 (2000) by evaluating peak height as a difference between the absorption on a peak maximum Aₚ at 607.5 cm⁻¹ and the absorption of a baseline A_{B} at this same wavenumber, and multiplication by a calibration factor
$$[ {C}_{s} ] = \frac{0.74 \cdot {10}^{- 3} \cdot 23.03}{X} ( {A}_{p} - {A}_{B} )$$
(concentration indicated in ppba) taking into account the sample thickness X.

4. The method as claimed in claim 3, wherein the correction value Y(w) is calculated according to Y(w)=m·p(w) with
$$m = \frac{( \frac{x - b}{x - a} ) \cdot [ ( k \cdot {R}_{0} ( a ) ) - {R}_{0} ( b ) ]}{( \frac{x - b}{x - a} ) - k} and$$
$$p ( w ) = \frac{x - w}{x - b} ,$$
and the corrected reference spectrum R_{c}(w) is calculated from this according to R_{c}(w)=R₀(w)+Y(w).
